(19) United States
(12) Patent Application Publication
(10) Pub. No.: US 2013/0093894 A1
(43) Pub. Date: Apr. 18, 2013

(54) COUNTER SURVEILLANCE SYSTEM

(71) Applicant: Andrey Zlotnikov, Kfar Yona (IL)

(72) Inventor: Andrey Zlotnikov, Kfar Yona (IL)

(21) Appl. No.: 13/805,870

(22) PCT Filed: May 1, 2012
(86) PCT No.: PCT/IL12/00177

§ 371 Date: Dec. 20, 2012

(30) Foreign Application Priority Data
May 18, 2011 (IL) 212972

(51) Int. Cl. H04N 7/18

(52) U.S. Cl. CPC H04N 7/18
USPC 348/148

(57) ABSTRACT

Vehicle mounted cameras are used as counter surveillance devices to detect surveillance of a protected vehicle. These cameras are located in forward and rearward looking locations in the protected vehicle and are in communication with vision processing software that a.) identifies license tags of surrounding vehicles, which are then run through various data-bases of friends and foes, and b.) records surrounding vehicle movements in an attempt to identify trailing vehicles that (for instance) remain within a certain distance of the protected vehicle for long periods of time, or fit other criteria.

### BACKGROUND

1. Technical Field

Embodiments of the present invention relate generally to systems and methods for counter surveillance, particularly in vehicle based applications.

2. Description of Related Art

There arise situations when individuals may suspect that they are being followed. For example an adulteress may suspect that her cuckolded husband has hired a surveillance professional to track and record her movements, conversations, and other actions. Thus various counter surveillance techniques have been developed, including signal intelligence methods adapted to detect phone taps and the like, human intelligence methods involving covert surveillance of a subject and his surroundings in an attempt to discover any other covert operatives, and the like.

However no system for counter surveillance of vehicles under observation has been disclosed that takes advantage of various advances in technical resources now available. Hence, an improved method for vehicle counter surveillance is still a long felt need.

### BRIEF SUMMARY

According to an aspect of the present invention, there is provided a system and method for counter surveillance. Vehicle mounted cameras are used as counter surveillance devices to detect surveillance of a protected vehicle. These cameras are located in forward and rearward looking locations in the protected vehicle and are in communication with vision processing software that a.) identifies license tags which are then run through various databases of friends and foes, and b.) records surrounding vehicle movements in an attempt to identify trailing vehicles that (for instance) remain within a certain distance of the protected vehicle for long periods of time, or fit other criteria.

It is within provision of the invention to afford a method of surveillance detection comprising steps of:
a. providing a set of detectors;
b. providing computing means in communication with said detectors;
c. providing a database of known surveillance characteristics;
d. determining if the detected data falls into any category of known surveillance activity.

It is within provision of the invention to further issue an alert upon determining that detected data falls into a category of known surveillance activity.

It is within provision of the invention wherein said detectors are video detectors, and said database comprises vehicle identification numbers.

It is within provision of the invention wherein said known surveillance characteristics include movements of vehicles.

It is within provision of the invention wherein said known surveillance characteristics include movements of humans.

It is within provision of the invention wherein said detectors are selected from the group consisting of: video cameras; radio receivers; optical spectrometers; mass spectrometers; near field monitors; load analyzers; spectrum analyzers; vibration detectors; camera detectors; wireless detectors; radar.

It is within provision of the invention wherein said detectors and computing means are hidden within a vehicle.

It is within provision of the invention wherein said database includes information selected from the group consisting of: vehicle surveillance patterns; vehicle identification characteristics; face data; distinguishing mark data; surveillance equipment frequencies; mass spectra; optical spectra; power spectra.

It is within provision of the invention wherein said step of determining if detected data falls into any category of known surveillance activity is accomplished by means of an algorithm selected from the group consisting of: gradient descent, simplex, convex minimization, neural networks, Bayesian networks, support vector machine, linear programming methods, nonlinear programming methods, Hessian methods, gradient methods, thermodynamic methods, entropic methods, and simulated annealing.

It is within provision of the invention where said computing means comprises vision processing means; audio processing means; spectrum analysis means; pattern detection means.

It is an object of the invention to provide a system for surveillance detection comprising:
a. a set of detectors;
b. computing means in communication with said detectors;
c. a database of known surveillance characteristics;
d. means for determining if detected data falls into any category of known surveillance activity.

It is within provision of the invention further issuing an alert upon determining that detected data falls into a category of known surveillance activity.

It is within provision of the invention wherein said detectors are video detectors, and said database comprises vehicle identification numbers.

It is within provision of the invention wherein said known surveillance characteristics include movements of vehicles.

It is within provision of the invention wherein said known surveillance characteristics include movements of humans.

It is within provision of the invention wherein said detectors are selected from the group consisting of: video cameras; radio receivers; optical spectrometers; mass spectrometers; near field monitors; load analyzers; spectrum analyzers; vibration detectors; camera detectors; wireless detectors; radar.

It is within provision of the invention wherein said detectors and computing means are hidden within a vehicle.

It is within provision of the invention wherein said database includes information selected from the group consisting of: vehicle surveillance patterns; vehicle identification characteristics; face data; distinguishing mark data; surveillance equipment frequencies; mass spectra; optical spectra; power spectra.

It is within provision of the invention wherein said step of determining if detected data falls into any category of known surveillance activity is accomplished by means of an algorithm selected from the group consisting of: gradient descent, simplex, convex minimization, neural networks, Bayesian networks, support vector machine, linear programming methods, nonlinear programming methods, Hessian methods, gradient methods, thermodynamic methods, entropic methods, and simulated annealing.

It is within provision of the invention where said computing means comprises vision processing means; audio processing means; spectrum analysis means; pattern detection means.

It is within provision of the invention that in the case that the vehicle alarm system (or other alarm system) is activated, the optical sensors (cameras or otherwise) of the system be activated and that data from such sensors be recorded, in an attempt to aide in identification of hostile entities.

It is within provision of the invention that data obtained by the sensors of the system be stored locally and/or sent over a communications link to external entities. The communications link may be of any sort found in the art, including radio, microwave, audio, optical, cellular, wireless, or the like.

It is within provision of the invention that the computing means of the system be in communication with databases such as police database, intelligence apparatus databases, and the like including databases of known felons, wanted individuals, stolen vehicles, and the like. It is thus likewise within provision of the invention that when a stolen vehicle is identified within proximity of the vehicle to be protected, the system issues an alert to the occupants of the vehicle to be protected to this effect.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 illustrates a vehicle outfitted with sensors consistent with operation of the invention;

FIG. 2 illustrates a typical shadowing procedure known as the ‘moving box’.

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a system and method for counter surveillance.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

The term ‘plurality’ refers hereinafter to any positive integer (e.g, 1,5, or 10).

The term ‘protected vehicle’ refers hereinafter to a vehicle enjoying the benefits of the disclosed invention, allowing discovery of surveillance of said vehicle.

According to an aspect of the present invention, there is provided a system and method for counter surveillance. Vehicle mounted cameras are used as counter surveillance devices to detect surveillance of a protected vehicle. These cameras are located in forward and rearward looking locations in the protected vehicle and are in communication with vision processing software that a.) identifies license tags which are then run through various databases of friends and foes, and b.) records surrounding vehicle movements in an attempt to identify trailing vehicles that (for instance) remain within a certain distance of the protected vehicle for long periods of time, or fit other criteria.

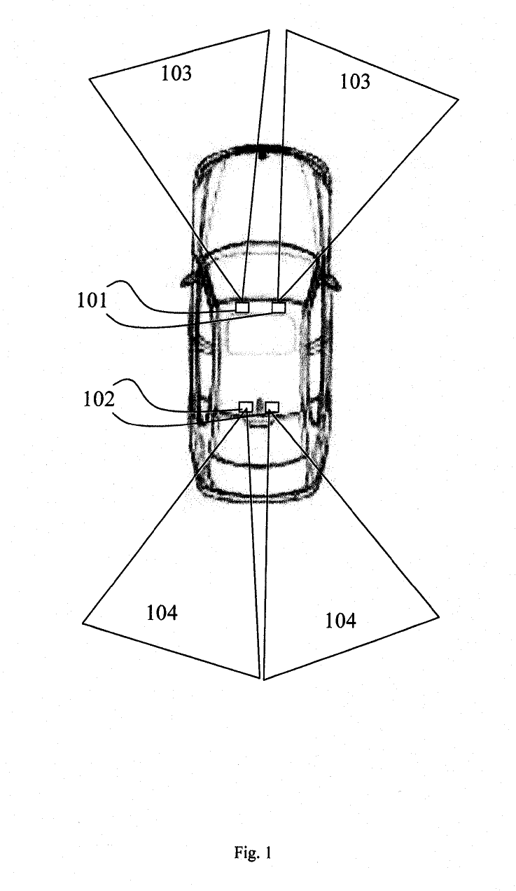

As shown in FIG. 1 a basic tool of the invention involves the use of forward looking cameras 101 and rearward looking cameras 102. These cameras have fields of view 103, 104 which generally speaking will cover some solid angle out of the total field of view. Obviously side looking cameras or cameras with larger or smaller fields of view or depths of field can be used. The point is that once a number of video surveillance devices are placed on the vehicle to be protected, this video information is processed automatically using vision processing software and/or hardware adapted to recognize several key elements of a scence, including but not limited to: license plate numbers; faces; weapons; insignia; distinguishing characteristics and/or markings (on vehicles, personnel and the like); and others as will be clear to one skilled in the art. These cameras will preferably be placed in hidden locations, for example behind one-way mirrors, under dashboards, within vehicle light fixtures, behind the radiator grille, within the bumper, within door panels, or the like. Obviously any form of camera or detector useful for such detection is within scope of the invention, including infrared cameras, spectrometers (useful for matching paints for example), and the like.

Using such detectors and associated signal processing means such as vision recognition software, license tags, faces, paint compositions, and other distinguishing marks can be compared to their equivalents in online and/or offline databases with which the computing device of the invention is in communication. Thus for example if the user has access to an online library of unmarked police car license tags, if these are being used for surveillance of a protected vehicle they will be immediately detected by the system and the driver alerted that he/she is under surveillance.

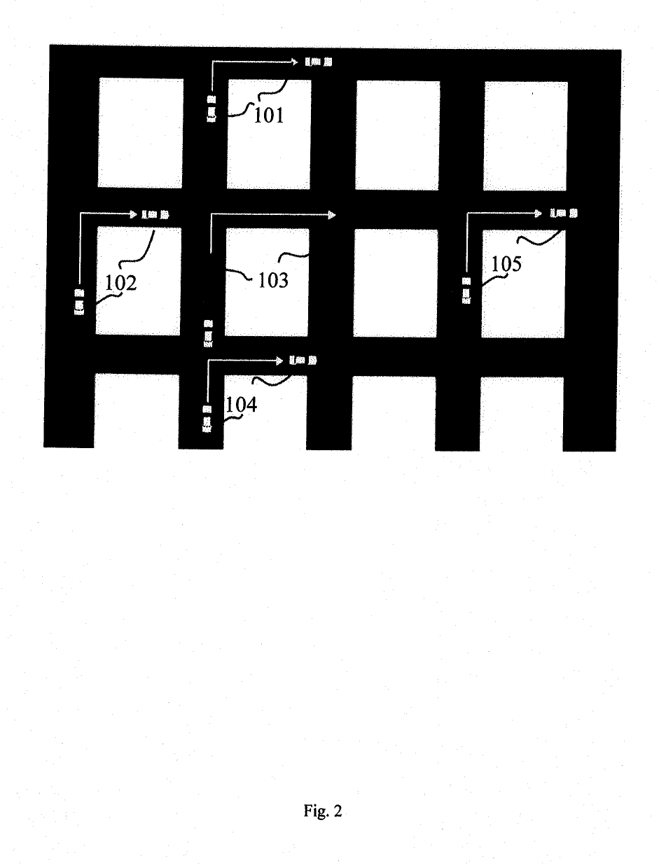

It is within provision of the invention to furthermore discover the employment of common surveillance techniques. For this purpose let us consider a typical vehicle surveillance technique, the ‘floating box’ as illustrated in FIG. 2. At a typical intersection, the ‘target’ vehicle 103 (this being the vehicle under surveillance) can proceed in several directions. One or more surveillance vehicles 101,102,104,105 are emplaced around the target. Each surveillance vehicle covers one possible route that the target might take. The advance vehicle 101 actually precedes the target vehicle.

When the target makes a right turn at an intersection (as shown in FIG. 2) the right-side outrider 105 also turns right—and becomes the new advance vehicle. As shown in the figure, vehicles 102, 104, and 101 similarly take right turns, mirroring the actions of the target and effectively ‘boxing in’ the target vehicle such that it is always surrounded by surveillance vehicles. As will be appreciated by one skilled in the art, this technique can be difficult to detect since the constellation of following vehicle(s) will change depending on the target vehicle movements. However an automatic system will easily detect such movements as it will keep a list of all vehicle tags recognised. If a small group (for example four or five) of vehicles is recognised to be within a given distance (for example a kilometer or two) for a given period of time (for example 10 or 20 minutes), then the system can issue an alert. Furthermore if the particular movements of the vehicles recognised comports with the ‘floating box’ described above, the system can likewise issue an alert.

As will be appreciated by one skilled in the there are a number of different standard configurations for surveillance of the type described above; different maneuvers may be standard for different situations. Thus it is within provision of the invention that a ‘play book’ of such tactics be stored in a database of the invention. Then by automated analysis of surrounding vehicle movements, any known surveillance pattern can be detected automatically and without requiring the parties under surveillance to remember lists of license numbers or the like.

For the detection of surveillance by airplane and/or UAV, it is within provision of the invention to use a high-powered roof camera to survey the sky in area sweeps, locking onto suspected aircraft by means of vision processing software. Thus if a typical surveillance aircraft outline is detected, the system may issue an alert for this case well.

It is within provision of the invention to utilize sensitive radio receivers to uncover surveillance activity as well. As before, the detectors are put into communication with software adapted for pattern recognition based on libraries of known characteristics, such as power spectra, frequency spectra etc. as used by law enforcement agencies, surveillance professionals, and the like. For example, the “Xandi Electronics” bug kit transmits at 143.4 MHz; thus if a power spectrum reveals this frequency being used, an alert may be issued to the protected vehicle.

Similarly, optical wavelength detectors may be used with appropriate software to detect common frequencies of lasers used in various surveillance operations.

As should be clear to one skilled in the art, the present state of algorithmic pattern detection is such that very general solutions to the compounded difficulties f counter surveillance are readily at hand. In fact, once the relevant data has been obtained by the detectors (cameras, radars, radio equipment and the like), they may be rather easily compared to databases of known surveillance equipment, methods, personnel or the like by means of algorithms such as : gradient descent, simplex, convex minimization, neural networks, Bayesian networks, support vector machine, linear programming methods, nonlinear programming methods, Hessian methods, gradient methods, thermodynamic methods, entropic methods, and simulated annealing.

Many of these algorithms are ‘trainable’ in the sense that they will classify data as suspicious or nonsuspicious (for example) after being presented a number of training examples. Thus for example a number of human faces may be presented to such a system, some of which are surveillance personnel wearing ‘hidden’ earbuds. These earbuds are actually visibly detectable by optical means even though such detection will generally be difficult for a human observer. However for a high resolution camera, the telltale signs of an earbud are readily apparent, and thus if for example a support vector machine algorithm is trained with a set of known earbud wearing subjects and a set of known innocent subjects, the system will ‘learn’ the relevant characteristics (without any explicit training as to what an earbud-wearing person looks like) and be able to detect such in the future without human intervention, within the known limits of such systems and their inherent errors.

It is within provision of the invention that in the case that the vehicle alarm system (or other alarm system) is activated, the optical sensors (cameras or otherwise) of the system be activated and that data from such sensors be recorded, in an attempt to aide in identification of hostile entities.

It is within provision of the invention that data obtained by the sensors of the system be stored locally and/or sent over a communications link to external entities. The communications link may be of any sort found in the art, including radio, microwave, audio, optical, cellular, wireless, or the like.

It is within provision of the invention that the computing means of the system be in communication with databases such as police database, intelligence apparatus databases, and the like including databases of known felons, wanted individuals, stolen vehicles, and the like. It is thus likewise within provision of the invention that when a stolen vehicle is identified within proximity of the vehicle to be protected, the system issues an alert to the occupants of the vehicle to be protected to this effect.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

1. A method of surveillance detection comprising steps of:
a. providing a set of detecting means;
b. providing computing means in communication with said detectors adapted to analyze data from said set of detectors;
c. comparing said data with a database of known surveillance characteristics;
d. determining if the detected data falls into any category of known surveillance activity.

2. The method of claim 1 further issuing an alert upon determining that detected data falls into a category of known surveillance activity.

3. The method of claim 1 wherein said database comprises vehicle identification numbers.

4. The method of claim 1 wherein said known surveillance characteristics include movements of vehicles.

5. The method of claim 1 wherein said known surveillance characteristics include movements of humans.

6. The method of claim 1 wherein said detectors are selected from the group consisting of: video cameras; radio receivers; optical spectrometers; mass spectrometers; near field monitors; load analyzers; spectrum analyzers; vibration detectors; camera detectors;
wireless detectors; radar.

7. The method of claim 1 wherein said detectors and computing means are hidden within a vehicle.

8. The method of claim 1 wherein said database includes information selected from the group consisting of: vehicle surveillance patterns; vehicle identification characteristics;
face data; distinguishing mark data; surveillance equipment frequencies; mass spectra; optical spectra; power spectra.

9. The method of claim 1 wherein said step of determining if detected data falls into any category of known surveillance activity is accomplished by means of an algorithm selected from the group consisting of: gradient descent, simplex, convex minimization, neural networks, Bayesian networks, support vector machine, linear programming methods, nonlinear programming methods, Hessian methods, gradient methods, thermodynamic methods, entropic methods, and simulated annealing.

10. The method of claim 1 where said computing means comprises vision processing means; audio processing means; spectrum analysis means; pattern detection means.

11. The method of claim 1 wherein said database contains data selected from the group consisting of: stolen vehicle identification data; hostile entity identification data; criminal element identification data.

12. A system for surveillance detection comprising:
a. a set of detecting means;
b. computing means in communication with said detectors adapted to analyze data from said set of detectors;
c. a database of known surveillance characteristics;
d. means for determining if detected data falls into any category of known surveillance activity by comparing said data to said database.

13. The system of claim 12 further issuing an alert upon determining that detected data falls into a category of known surveillance activity.

14. The system of claim 12 wherein said database comprises vehicle identification numbers.

15. The system of claim 12 wherein said known surveillance characteristics include movements of vehicles.

16. The system of claim 12 wherein said known surveillance characteristics include movements of humans.

17. The system of claim 12 wherein said detectors are selected from the group consisting of: video cameras; radio receivers; optical spectrometers; mass spectrometers; near field monitors; load analyzers; spectrum analyzers; vibration detectors; camera detectors; wireless detectors; radar.

18. The system of claim 12 wherein said detectors and computing means are hidden within a vehicle.

19. The system of claim 12 wherein said database includes information selected from the group consisting of: vehicle surveillance patterns; vehicle identification characteristics; face data; distinguishing mark data; surveillance equipment frequencies; mass spectra; optical spectra; power spectra.

20. The system of claim 12 wherein said step of determining if detected data falls into any category of known surveillance activity is accomplished by means of an algorithm selected from the group consisting of: gradient descent, simplex, convex minimization, neural networks, Bayesian networks, support vector machine, linear programming methods, nonlinear programming methods, Hessian methods, gradient methods, thermodynamic methods, entropic methods, and simulated annealing.

21. The system of claim 12 where said computing means comprises vision processing means; audio processing means; spectrum analysis means; pattern detection means.

22. The system of claim 12 wherein said database contains data selected from the group consisting of: stolen vehicle identification data; hostile entity identification data; criminal element identification data.
